(19) United States
(12) Patent Application Publication
(10) Pub. No.: US 2016/0355015 A1
(43) Pub. Date: Dec. 8, 2016

(54) LIQUID EJECTING APPARATUS

(71) Applicant: Seiko Epson Corporation, Tokyo (JP)

(72) Inventors: Toru KASHIMURA, Shiojiri (JP); Hiroshi SUGITA, Shiojiri (JP)

(21) Appl. No.: 15/241,428

(22) Filed: Aug. 19, 2016

Related U.S. Application Data
(62) Division of application No. 14/520,680, filed on Oct. 22, 2014.

(30) Foreign Application Priority Data
Nov. 27, 2013 (JP) 2013-244993

(51) Int. Cl. B41J 2/14

(52) U.S. Cl. CPC B41J 2/14201

(57) ABSTRACT

A liquid ejecting apparatus includes a signal modulation section that causes an original drive signal to be pulse-modulated to generate a modulation signal, a signal amplification section that amplifies the modulation signal to generate an amplification modulation signal, a coil that smooths the amplification modulation signal to generate a drive signal, a piezoelectric element that deforms when the drive signal is applied thereto, a cavity that expands or contracts due to deformation of the piezoelectric element, and a nozzle that communicates with the cavity and ejects a liquid in accordance with increase and decrease of a pressure inside the cavity. The coil is a metallic alloy type.

### CROSS-REFERENCE TO RELATED APPLICATIONS

This is a continuation patent application of U.S. application Ser. No. 14/520,680 filed Oct. 22, 2014, which claims priority to Japanese Patent Application No. 2013-244993, filed Nov. 27, 2013, both of which are expressly incorporated by reference herein in their entireties.

### BACKGROUND

1. Technical Field

The present invention relates to a liquid ejecting apparatus which applies a drive signal to an actuator to eject a liquid. For example, the invention is suitable for a liquid ejecting-type printing apparatus which ejects a fine liquid from a nozzle of a liquid ejecting head and forms minute particles (dots) on a printing medium, thereby printing predetermined characters, images, and the like.

2. Related Art

As an example of a liquid ejecting apparatus, there is a known ink jet printer which ejects an ink (liquid) toward a recording medium from a nozzle provided in a head. Generally, a nozzle row having multiple nozzles arranged in a predetermined direction is formed in the head, for example, there is a known serial head method in which the head relatively moves in a direction in which a scanning direction of the head intersects a transportation direction of the recording medium and ejects an ink to print an image in a width of the nozzle row. As disclosed in JP-A-2011-5733, there is also a known line head method in which nozzles are disposed in a row shape in a direction intersecting a transportation direction of a recording medium and an image is printed when the recording medium passes therebelow.

JP-A-2011-5733 discloses an exemplification in which a secondary filter consisting of one capacitor C and a coil L is used as a smooth filter, without specifying which type of the coil L needs to be used.

A coil used in smoothing an amplification modulation signal from a digital power amplification circuit generally tends to be great in heat generation and a loss, and thus, selection of a coil which can prevent heat generation and heat loss from occurring is a major disadvantage in designing a liquid ejecting-type printing apparatus. Particularly, in a printer, since an amplification modulation signal at a high frequency such as a MHz order is used in order to obtain a printed matter having sufficient quality and resolution, it is difficult to use a method of selecting a coil adopted in other electronic apparatuses (for example, an ordinary audio apparatus uses a frequency such as 32 kHz, 64 kHz, or 128 kHz) as it is.

### SUMMARY

An advantage of some aspects of the present invention is to provide a liquid ejecting-type printing apparatus of low power consumption that can select the coil having high conversion efficiency which can prevent heat generation and heat loss from occurring when smoothing the amplification modulation signal, for example, in the liquid ejecting-type printing apparatus such as an ink jet printer using the amplification modulation signal at a high frequency.

(1) According to an aspect of the invention, there is provided a liquid ejecting apparatus including a signal modulation section that causes an original drive signal to be pulse-modulated to generate a modulation signal, a signal amplification section that amplifies the modulation signal to generate an amplification modulation signal, a coil that smooths the amplification modulation signal to generate a drive signal, a piezoelectric element that deforms when the drive signal is applied thereto, a cavity that expands or contracts due to deformation of the piezoelectric element, and a nozzle that communicates with the cavity and ejects a liquid in accordance with the increase and decrease of a pressure inside the cavity. The coil is a metallic alloy type.

In this case, the liquid ejecting apparatus, the amplification modulation signal at a high frequency generated in the signal amplification section (for example, digital power amplification circuit) is input to the coil. For this reason, an iron loss (loss of core material) is often more dominant than a copper loss (loss of wire material) as a factor increasing heat generation or power consumption of the coil. The liquid ejecting apparatus according to the aspect of the invention uses the metallic alloy-type coil, and thus, it is possible to make an optimal selection of a core material and to prevent an eddy-current loss which accounts for a large portion of the iron loss. Since the coil which can attain high conversion efficiency without increasing heat generation or power consumption while preventing the iron loss is used, it is possible to realize low power consumption in the liquid ejecting apparatus according to the aspect of the invention. The metallic alloy-type coil is formed by integrally molding a metallic core having no magnetic saturation and a winding wire. Therefore, it is possible to allow a relatively large current to flow for a small-type coil, and there is no magnetic leakage in a closed magnetic circuit.

The original drive signal indicates an original signal of a drive signal which controls deformation of a piezoelectric element, that is, a signal before being modulated which becomes a reference of a waveform. The modulation signal indicates a digital signal which can be obtained by causing the original drive signal to be pulse-modulated (for example, pulse width modulation, pulse density modulation and the like), and the signal modulation section indicates a modulation circuit performing the pulse modulation. The signal amplification section indicates a digital power amplification circuit including a half bridge output stage, for example, and the amplification modulation signal indicates a modulation signal amplified in the signal amplification section. The drive signal indicates a signal which can be obtained by smoothing the amplification modulation signal using a coil, and the drive signal is applied to the piezoelectric element.

(2) According to the aspect of the invention, a frequency band of an AC component of the amplification modulation signal may be equal to or higher than 1 MHz.

In this case, the amplification modulation signal is smoothed to generate the drive signal, and a liquid is ejected from the nozzle based on deformation of the piezoelectric element to which the drive signal is applied. According to a frequency spectrum analysis performed upon a waveform of the drive signal for the liquid ejecting apparatus ejecting small dots (minute dots), it has been learned that a frequency component equal to or lower than 50 kHz is included. In order to amplify an original drive signal including this frequency component of 50 kHz through the digital power amplification circuit (corresponding to signal amplification section), a modulation signal (amplification modulation signal) including a frequency component equal to or higher than 1 MHz is needed. If reproducing of the original drive signal is attempted with only the frequency component equal to or lower than 1 MHz, the edge of the waveform becomes obtuse and rounded. In other words, sharpness disappears and the waveform becomes obtuse. If the waveform of the drive signal becomes obtuse, movements of the piezoelectric element which is operated in accordance with the rising edge and falling edge of the waveform become dull, thereby causing an occurrence of unstable driving such as tailing or ejection failure during ejection. The liquid ejecting apparatus of the invention has the frequency band of an AC component of the amplification modulation signal equal to or higher than 1 MHz so that there is no unstable driving such as the tailing or the ejection failure during ejection, thereby making it possible to realize the liquid ejecting apparatus which can obtain a product having high resolution.

(3) According to the aspect of the invention, a frequency band of an AC component of the amplification modulation signal may be lower than 8 MHz.

In this case, if a high frequency equal to or higher than 8 MHz is supported as a frequency of the amplification modulation signal, resolving power of the waveform of the drive signal is enhanced, but a switching frequency in the digital power amplification circuit (corresponding to signal amplification section) rises in accordance with improvement in the resolving power. If the switching frequency rises, a switching loss becomes significant, resulting in impairment of a power saving property and a low pyrogenic property in which a digital amplifier is relatively advantageous compared to an amplifier of class AB. Thus, it may be desirable to perform amplification by using the amplifier of class AB. In the liquid ejecting apparatus of the invention, the frequency band of the AC component of the amplification modulation signal is caused to be lower than 8 MHz, and it is possible to maintain advantages of low power consumption and low heat generation compared to a case using the amplifier of class AB.

(4) According to the aspect of the invention, a core material of the coil may be a powder alloy which uses powder containing Fe, Si, and Cr as components.

(5) According to the aspect of the invention, the powder may contain Fe as a main component, have an average particle size ranging from 5 μm to 25 μm, and have a maximum particle size of less than 63 μm.

In this case, for example, it is possible to realize a low-loss coil which is suitable to be used in a liquid ejecting-type printing apparatus such as an ink jet printer using the amplification modulation signal at a high frequency, and in which a loss in a high frequency band (iron loss) is small. Therefore, the liquid ejecting apparatus according to the aspect of the invention can realize low power consumption.

(6) According to the aspect of the invention, the powder may contain Si at a content rate ranging from 1% by weight to 8% by weight.

In this case, magnetic permeability can be enhanced in the coil. Since specific resistance can also be increased, it is possible to decrease an induced current generated in a dust core, and to decrease an eddy-current loss. Therefore, the liquid ejecting apparatus according to the aspect of the invention can realize low power consumption.

(7) According to the aspect of the invention, the powder may contain Cr at a content rate ranging from 1% by weight to 13% by weight.

In this case, a coil having excellent corrosion resistance can be realized. Since the specific resistance can also be enhanced, it is possible to decrease an induced current generated in the dust core, and to decrease the eddy-current loss. Therefore, the liquid ejecting apparatus according to the aspect of the invention excels in long-term reliability and can realize low power consumption.

(8) According to the aspect of the invention, the core material of the coil may contain a mixture of the powder and a binding material, and a ratio of the binding material to the powder may range from 0.5% by weight to 5% by weight.

In this case, each of the particles included in the powder is securely insulated from each other, and a certain degree of density of the dust core is secured, and thus, it is possible to prevent the magnetic permeability and magnetic flux density of the dust core from being remarkably lowered. As a result, a low-loss coil can be realized. Therefore, the liquid ejecting apparatus according to the aspect of the invention can realize low power consumption.

(9) According to the aspect of the invention, a loss of the core material may be greater than a loss of a wire material in the coil during a normal operation.

In this case, the expression “during a normal operation” indicates a state where a liquid ejecting apparatus is in normal use and a product can be obtained through ejection of a liquid thereof. In this case, an amplification modulation signal in a predetermined frequency band (for example, 1 MHz to 8 MHz) is input to the coil of the liquid ejecting apparatus of the embodiment. In the coil of the liquid ejecting apparatus of the embodiment, the iron loss (loss of core material) is greater than the copper loss (loss of wire material) with respect to the overall frequencies. The coil of the liquid ejecting apparatus of the embodiment, being a metallic alloy type, can particularly suppress the iron loss which is dominant during the normal operation. Therefore, the liquid ejecting apparatus according to the aspect of the invention can realize low power consumption.

### BRIEF DESCRIPTION OF THE DRAWINGS

The invention will be described with reference to the accompanying drawings, wherein like numbers reference like elements.

FIG. 1 is a block diagram illustrating an overall configuration of a printing system.

FIG. 2 is a schematic cross-sectional view of a printer.

FIG. 3 is a schematic top view of the printer.

FIG. 4 is a view for describing a structure of a head.

FIG. 5 is a view for describing a drive signal which is from a drive signal generation section, and a control signal which is used in forming dots.

FIG. 6 is a block diagram describing a configuration of a head control section.

FIG. 7 is a view describing a flow up to generation of the drive signal.

FIG. 8 is a detailed block diagram of the drive signal generation section and the like.

FIG. 9A is a view describing a configuration of a core material of a dust core-based coil.

FIG. 9B is a cross-sectional view of the coil when using ferrite.

FIG. 9C is a cross-sectional view of the coil of the embodiment.

FIG. 10 is a view describing a ratio of a copper loss to an iron loss in Rs.

FIG. 11A is a view describing a ratio of an eddy-current loss to a hysteresis loss.

FIG. 11B is a view for describing an eddy-current.

FIGS. 12A and 12B are views describing relationship between the maximum particle size of the powder and a loss of the core used in the core material of the coil in the embodiment.

FIG. 13 is a spectrum analysis diagram of an original drive signal.

### DESCRIPTION OF EXEMPLARY EMBODIMENTS

### 1. Configuration of Printing System

A configuration applied to a liquid ejecting-type printing apparatus will be described as an embodiment of a liquid ejecting apparatus according to the invention.

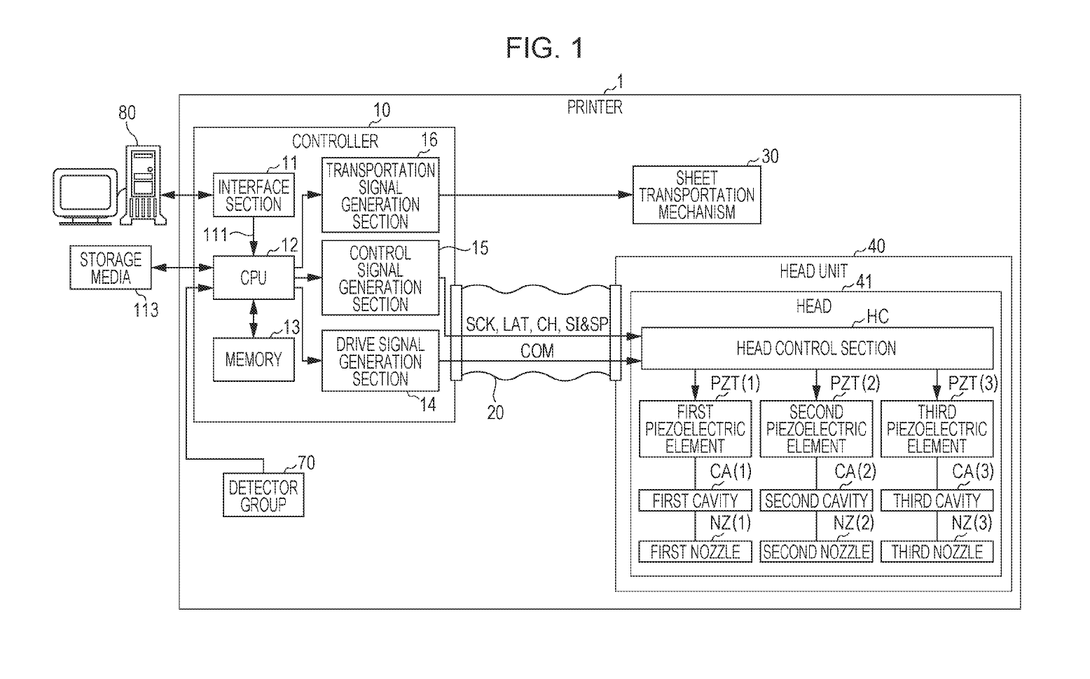

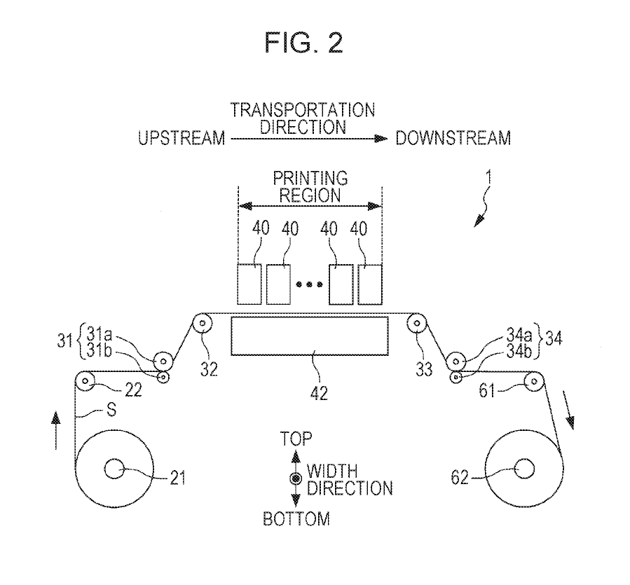

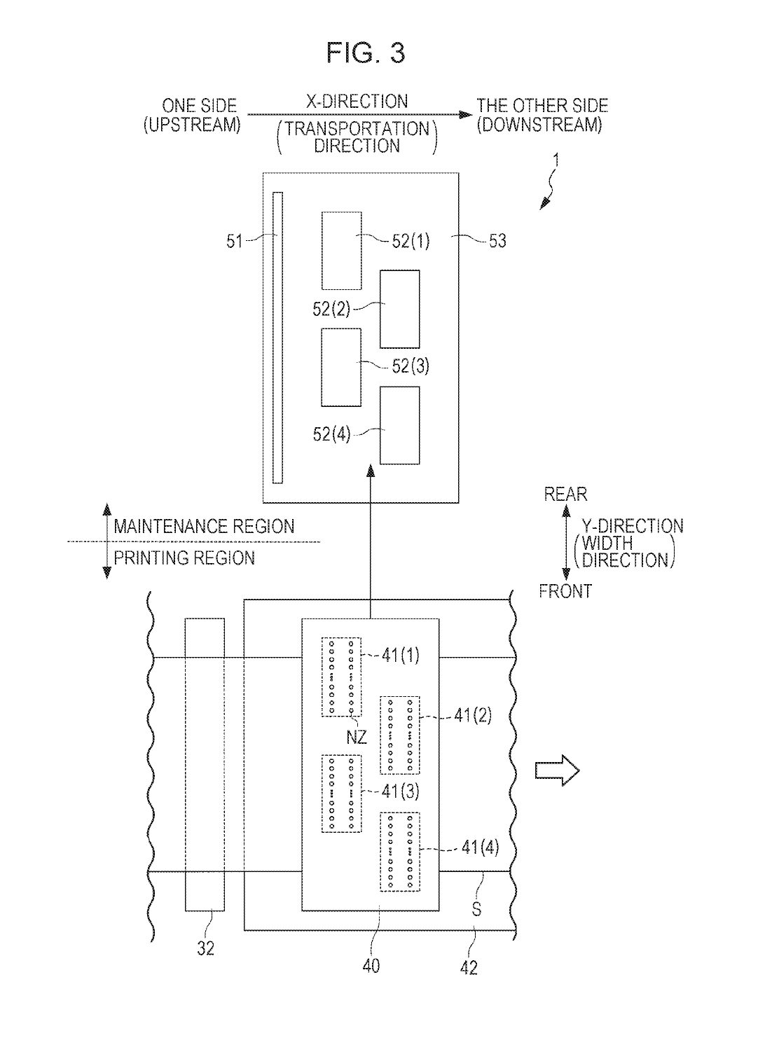

FIG. 1 is a block diagram illustrating an overall configuration of a printing system including a liquid ejecting-type printing apparatus (printer 1) of the present embodiment. As described below, the printer 1 is a line head printer in which a sheet S (refer to FIGS. 2 and 3) is transported in a predetermined direction and is printed in a printing region during the transportation thereof.

The printer 1 is connected to a computer 80 to be able to communicate with each other. A printer driver installed inside the computer 80 creates printing data to cause the printer 1 to print an image, and outputs the data to the printer 1. The printer 1 has a controller 10, a sheet transportation mechanism 30, a head unit 40 and a detector group 70. As described below, the printer 1 may include a plurality of head units 40. However, one head unit 40 will be described herein as a representative unit illustrated in FIG. 1.

The controller 10 inside the printer 1 performs overall controlling in the printer 1. An interface section 11 transceiver data with respect to the computer 80, which is an external apparatus. The interface section 11 outputs a piece of printing data 111 among pieces of data received from the computer 80 to a CPU 12. The printing data 111 includes image data, data designating a printing mode, and the like.

The CPU 12 is an arithmetic processing unit performing the overall controlling of the printer 1 and controls the head unit 40 and the sheet transportation mechanism 30 via a drive signal generation section 14, a control signal generation section 15 and a transportation signal generation section 16. A memory 13 secures a storage region or a working region for a program and data of the CPU 12. The detector group 70 monitors circumstances in the printer 1, and the controller 10 performs the controlling based on a detected result from the detector group 70. The program and the data of the CPU 12 may be stored in a storage medium 113. The storage medium 113 may be any one of a magnetic disk such as a hard disk, an optical disk such as a DVD, a nonvolatile memory such as a flash memory, and the like, without being particularly limited. As in FIG. 1, the CPU 12 may be accessible to the storage medium 113 which is connected to the printer 1. The storage medium 113 may be connected to the computer 80, and the CPU 12 may be accessible (route not illustrated) to the storage medium 113 via the interface section 11 and the computer 80.

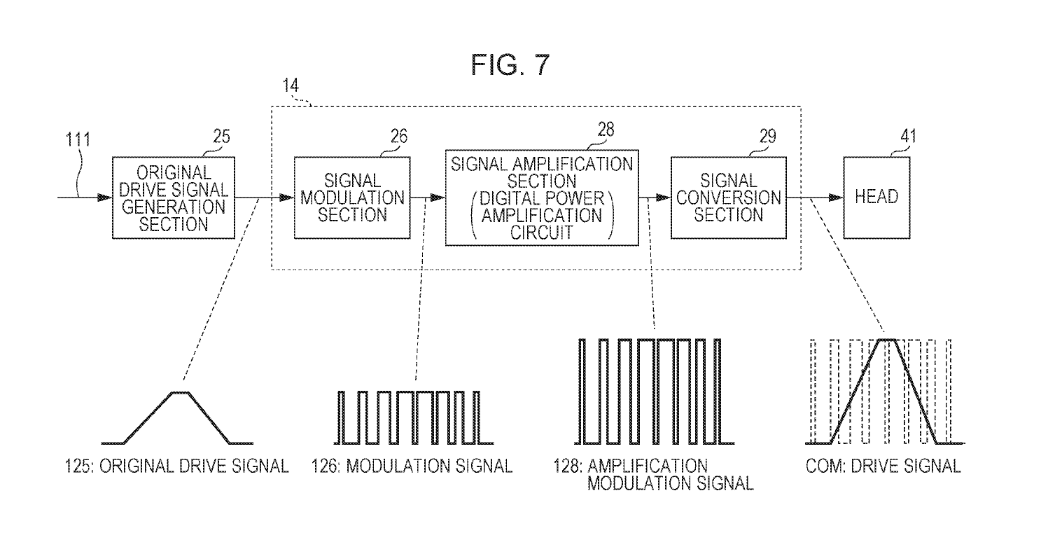

The drive signal generation section 14 generates a drive signal COM displacing a piezoelectric element PZT which is included in a head 41. As described below, the drive signal generation section 14 includes a portion of an original drive signal generation section 25, a signal modulation section 26, a signal amplification section 28 (digital power amplification circuit), and a signal conversion section 29 (smooth filter) (refer to FIG. 7). The drive signal generation section 14 following instructions from the CPU 12 generates an original drive signal 125 in the original drive signal generation section 25, causes the original drive signal 125 to be pulse-modulated in the signal modulation section 26 to generate a modulation signal 126, amplifies the modulation signal 126 in the signal amplification section 28, and smooths an amplification modulation signal 128 (amplified modulation signal 126) in the signal conversion section 29, thereby generating the drive signal COM.

The control signal generation section 15 follows instructions from the CPU 12 to generate a control signal. The control signal is a signal used for controlling the head 41, selecting a nozzle to eject a liquid, for example. In the embodiment, the control signal generation section 15 generates control signals including a clock signal SCK, a latch signal LAT, a channel signal CH and drive pulse selection data SI & SP, and these signals will be described below in detail. The control signal generation section 15 may be configured to be included in the CPU 12 (that is, a configuration in which the CPU 12 also performs a function of the control signal generation section 15).

The drive signal COM generated by the drive signal generation section 14 is an analog signal in which a voltage continuously changes. The control signals including the clock signal SCK, the latch signal LAT, the channel signal CH and the drive pulse selection data SI & SP are digital signals. The drive signal COM and the control signals are transmitted to the head 41 of the head unit 40 via a cable 20, that is, a flexible flat cable (hereinafter, also referred to as FFC). Regarding the control signal, a differential serial method may be used to transmit a plurality of types of the signals through time sharing. In this case, compared to a case of parallel transmission of the control signals classified by types, the number of transmission wire necessary can be reduced, thereby avoiding deterioration of a sliding property caused by many superposed FFC and causing a size of a connector provided in the controller 10 and the head unit 40 to be small.

The transportation signal generation section 16 following the instructions from the CPU 12 generates a signal to control the sheet transportation mechanism 30. The sheet transportation mechanism 30 rotatably supports the sheet S which is continuously wound in a roll shape, for example, and transports the sheet S by rotating, thereby printing a predetermined character, image or the like in the printing region. For example, the sheet transportation mechanism 30 transports the sheet S in a predetermined direction based on a signal generated in the transportation signal generation section 16. The transportation signal generation section 16 may be configured to be included in the CPU 12 (that is, a configuration in which the CPU 12 also performs a function of the transportation signal generation section 16).

The head unit 40 includes the head 41 as a liquid ejecting section. Due to limitations of space, only one head 41 is illustrated in FIG. 1. However, the head unit 40 according to the embodiment is regarded as having a plurality of heads 41. The head 41 has at least two actuator sections including the piezoelectric element PZT, a cavity CA and a nozzle NZ, and also includes a head control section HC controlling displacement of the piezoelectric element PZT. The actuator section includes the piezoelectric element PZT which is displaceable by the drive signal COM, the cavity CA which is filled with a liquid and in which an inside pressure is increased and decreased in accordance with the displacement of the piezoelectric element PZT, and a nozzle NZ which communicates with the cavity CA and ejects a liquid as a liquid droplet in accordance with the increase and decrease of a pressure inside the cavity CA. The head control section HC controls the displacement of the piezoelectric element PZT based on the drive signal COM and the control signal from the controller 10.

In order to distinguish elements included in each actuator section, a numeral in parenthesis is applied to the reference sign. In the example of FIG. 1, there are three actuator sections. A first actuator section includes a first piezoelectric element PZT(1), a first cavity CA(1) and a first nozzle NZ(1); a second actuator section includes a second piezoelectric element PZT(2), a second cavity CA(2) and a second nozzle NZ(2); and a third actuator section includes a third piezoelectric element PZT(3), a third cavity CA(3) and a third nozzle NZ(3). The actuator section may be two or four in number, for example, without being limited to being three. In FIG. 1, the first to third actuator sections are included in one head 41 for convenience of illustration. However, a portion of the actuators may be included in another head 41 (not illustrated).

The drive signal COM is generated in the drive signal generation section 14 as in FIG. 1, and transmitted to the first piezoelectric element PZT(1), the second piezoelectric element PZT(2) and the third piezoelectric element PZT(3) via the cable 20 and the head control section HC. The control signals including the clock signal SCK, the latch signal LAT, the channel signal CH and the drive pulse selection data SI & SP are generated in the control signal generation section 15 as in FIG. 1, and used for controlling in the head control section HC via the cable 20.

### 2. Configuration of Printer

FIG. 2 is a schematic cross-sectional view of the printer 1. In the example of FIG. 2, the sheet S is described as continuously wound paper in a roll shape. A recording medium on which the printer 1 prints an image may be cut paper, cloth, a film or the like, without being limited to the continuously wound paper.

The printer 1 has a feeding shaft 21 which feeds the sheet S by rotating, and a relay roller 22 which winds the sheet S fed from the feeding shaft 21 to be guided to a pair of upstream side transportation rollers 31. The printer 1 has a plurality of relay rollers 32 and 33 which wind and send the sheet S, the pair of upstream side transportation rollers 31 which are installed on an upstream side from the printing region in a transportation direction, and a pair of downstream side transportation rollers 34 which are installed on a downstream side from the printing region in the transportation direction. The pair of upstream side transportation rollers 31 and the pair of downstream side transportation rollers 34 respectively have driving rollers 31a and 34a connected to motors (not illustrated) for rotational driving, and driven rollers 31b and 34b rotating in accordance with rotations of the driving rollers 31a and 34a. A transportation force is applied to the sheet S in accordance with the rotational driving of the driving rollers 31a and 34a in a state where the pair of upstream side transportation rollers 31 and the pair of downstream side transportation rollers 34 respectively pinch the sheet S. The printer 1 has a relay roller 61 which winds and sends the sheet S sent from the pair of downstream side transportation rollers 34, and a winding driving shaft 62 which winds the sheet S sent from the relay roller 61. The printed sheet S is sequentially wound in a roll shape in accordance with the rotational driving of the winding driving shaft 62. The rollers or the motors (not illustrated) correspond to the sheet transportation mechanism 30 in FIG. 1.

The printer 1 has the head unit 40 and a platen 42 which supports the sheet S from an opposite side surface of a printing surface in the printing region. The printer 1 may include the plurality of head units 40. In the printer 1, for example, the head unit 40 may be prepared for each color of ink. The printer 1 may have a configuration in which four head units 40 which can eject inks in four colors, that is, yellow (Y), magenta (M), cyan (C) and black (B) are arranged in the transportation direction. In the description below, one head unit 40 is described as a representative unit. However, the colors of the ink are respectively allocated to the nozzles thereof, thereby making it possible to perform color printing.

As illustrated in FIG. 3, in the head unit 40, a plurality of heads 41(1) to 41(4) are arranged in a width direction (Y-direction) of the sheet S intersecting with the transportation direction of the sheet S. For convenience of description, numbers are applied in an ascending order from the head 41 on a further rear side in the Y-direction. On a surface facing the sheet S (bottom surface) in each head 41, multiple nozzles NZ ejecting an ink are arranged at predetermined intervals in the Y-direction. FIG. 3 virtually illustrates positions of the heads 41 and the nozzles NZ when the head unit 40 is seen from the top. The positions of the nozzles NZ in end portions of the heads 41 adjacent to each other in the Y-direction (for example, 41(1) and 41(2)) overlap each other at least in a portion, and the nozzles NZ are arranged at predetermined intervals in the Y-direction across a length equal to or wider than the width of the sheet S on the bottom surface of the head unit 40. Therefore, the head unit 40 ejects an ink from the nozzle NZ to the sheet S which is transported under the head unit 40 without stopping, thereby printing a two-dimensional image on the sheet S.

In FIG. 3, due to limitations of space, the heads 41 which belong to the head unit 40 are illustrated as four, but the number is not limited thereto. In other words, the number of head 41 may be more or less than four. The heads 41 in FIG. 3 are disposed in a zigzag grid shape, but the disposition is not limited thereto. As a method of ejecting an ink from the nozzle NZ, a piezoelectric type is adopted in the embodiment in which an ink is ejected by applying a voltage to the piezoelectric element PZT to expand and extract an ink chamber. However, a thermal type may be adopted in which an ink is ejected by air bubbles generated inside the nozzle NZ using a heating element.

In the embodiment, the sheet S is supported on a horizontal surface of the platen 42, but without being limited thereto, for example, a rotation drum which rotates around a rotating shaft in the width direction of the sheet S may be caused to serve as the platen 42, thereby ejecting an ink from the head 41 while winding the sheet S around the rotation drum to be transported. In this case, the head unit 40 is obliquely disposed along an outer circumferential surface of an arc shape of the rotation drum. If the ink ejected from the head 41 is an UV ink which is cured by irradiating ultraviolet rays, an irradiator for irradiating ultraviolet rays may be provided on a downstream side of the head unit 40.

The printer 1 is provided with a maintenance region for cleaning the head unit 40. There exist a wiper 51, a plurality of caps 52 and an ink reception section 53 in the maintenance region of the printer 1. The maintenance region is positioned on a rear side in the Y-direction from the platen 42 (that is, printing region), and the head unit 40 moves to the rear side in the Y-direction while cleaning.

The wiper 51 and the caps 52 are supported by the ink reception section 53 to be movable in an X-direction (transportation direction of sheet S) by the ink reception section 53. The wiper 51 is a plate-shaped member erected in the ink reception section 53 and formed of an elastic member, cloth, felt and the like. The caps 52 are rectangular parallelepiped members formed of the elastic members and the like, and are provided in each head 41. The caps 52(1) to 52(4) are arranged in the width direction corresponding to the disposition of the heads 41(1) to 41(4) in the head unit 40. Accordingly, if the head unit 40 moves to the rear side in the Y-direction, the heads 41 and the caps 52 face each other, and then, if the head unit 40 is lowered (or if the caps 52 are lifted), the caps 52 respectively adhere to nozzle opening surfaces of the heads 41, thereby making it possible to seal the nozzle NZ. The ink reception section 53 also functions to receive an ink ejected from the nozzles NZ while cleaning the heads 41.

When an ink is ejected from the nozzle NZ provided in the heads 41, fine ink droplets are generated together with main ink droplets, and the fine ink droplets fly about as a mist, thereby adhering to the nozzle opening surfaces of the heads 41. Not only the ink, but dust, paper powder and the like also adhere to the nozzle opening surfaces of the heads 41. If these foreign substances are left behind and accumulate and adhere to the nozzle opening surfaces of the heads 41, the nozzles NZ are blocked, thereby hindering ejection of ink from the nozzles NZ. Therefore, in the printer 1 according to the embodiment, a wiping treatment is periodically carried out as the cleaning of the head unit 40.

### 3. Drive Signal and Control Signal

Hereinafter, the drive signal COM and the control signal transmitted from the controller 10 via the cable 20 will be described in detail. Initially, a structure of the heads 41 will be described, and after waveforms of the drive signal COM and the control signal are exemplified, a configuration of the head control section HC will be described.

### 3.1. Structure of Head

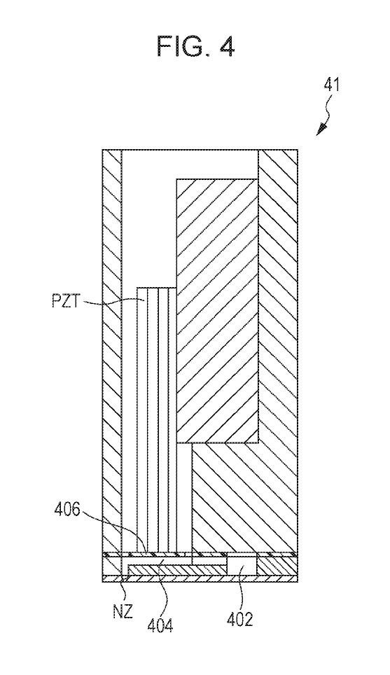

FIG. 4 is a view for describing a structure of the head 41. The nozzle NZ, the piezoelectric element PZT, an ink supply channel 402, a nozzle communication channel 404 and an elastic plate 406 are illustrated in FIG. 4. The ink supply channel 402 and the nozzle communication channel 404 correspond to the cavity CA.

The ink droplets are supplied through the ink supply channel 402 from an ink tank (not illustrated). Then, the ink droplets are supplied to the nozzle communication channel 404. A drive pulse PCOM of the drive signal COM is applied to the piezoelectric element PZT. When the drive pulse PCOM is applied, the piezoelectric element PZT expands and extracts (is displaced) in accordance with a waveform, thereby vibrating the elastic plate 406. The ink droplets in an amount corresponding to amplitude of the drive pulse PCOM are ejected from the nozzle NZ. The actuator sections configured to have the nozzles NZ, the piezoelectric element PZT and the like are arranged as in FIG. 3, thereby configuring the heads 41 having the nozzle rows.

### 3.2. Waveform of Signal

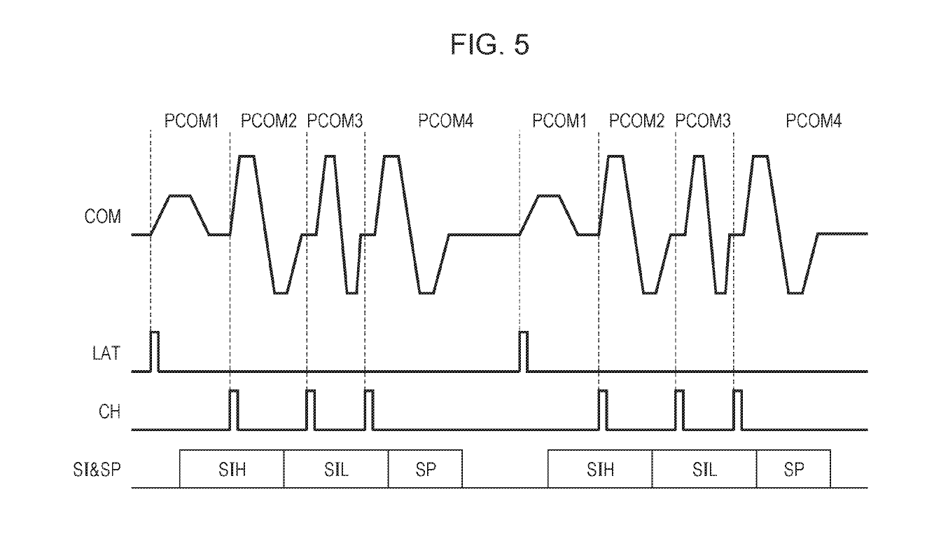

FIG. 5 is a view for describing the drive signal COM which is from the drive signal generation section 14 and the control signal which is used in forming dots. The drive signal COM is obtained by chronologically connecting the drive pulses PCOM, that is, unit drive signals applied to the piezoelectric element PZT to eject a liquid. A rising portion of the drive pulse PCOM indicates a stage in which volume of the cavity CA communicating with the nozzle is expanded to draw a liquid in, and a falling portion of the drive pulse PCOM indicates a stage in which the volume of the cavity CA is contracted to push a liquid out. As a result of pushing out a liquid, the liquid is ejected from the nozzle.

A draw-in amount or a draw-in speed of a liquid and a push-out amount or a push-out speed of the liquid can vary by variously changing an inclination of the increase and decrease in voltage and a peak value of the drive pulse PCOM formed by a voltage trapezoidal wave. Accordingly, it is possible to obtain the dot having various sizes by changing an ejecting amount of a liquid. Therefore, even in a case of chronologically connecting the plurality of drive pulses PCOM, it is possible to obtain the dots having various sizes by selecting a single drive pulse PCOM therefrom to be applied to the piezoelectric element PZT, thereby ejecting a liquid, or by selecting a plurality of the drive pulses PCOM to be applied to the piezoelectric element PZT, thereby ejecting a liquid a plurality of times. In other words, if a plurality of liquids are caused to impact onto the same position before the liquids dry, substantially the same effect can be achieved as ejecting a large amount of liquid, and thus, the dot can be increased in size. It is possible to achieve multi-gradation by combining such technologies. A drive pulse PCOM 1 at the left end in FIG. 5 only draws a liquid in without pushing any out, which is different from drive pulses PCOM 2 to PCOM 4. This is called a minute vibration and is used for suppressing and preventing thickening at the nozzle without ejecting an ink.

The clock signal SCK, the latch signal LAT, the channel signal CH and the drive pulse selection data SI & SP are input to the head control section HC as the control signals from the control signal generation section 15, in addition to the drive signal COM from the drive signal generation section 14. The latch signal LAT and the channel signal CH among these are the control signals determining an instant of time for the drive signal COM. As in FIG. 5, a series of drive signals COM begin to be output by the latch signal LAT so that a drive pulse PCOM is output for each channel signal CH. Pieces of the drive pulse selection data SI & SP include pieces of the pixel data SI (SIH, SIL) for designating the piezoelectric element PZT corresponding to the nozzle which is to eject an ink droplet, as well as a piece of waveform pattern data SP of the drive signal COM. The reference signs SIH and SIL respectively correspond to a high-order bit and a low-order bit of the 2-bit pixel data SI.

### 3.3. Head Control Section

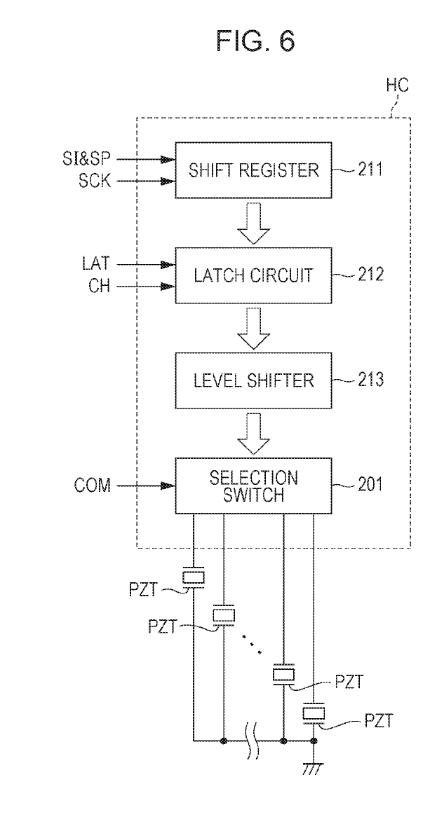

FIG. 6 is a block diagram describing a configuration of the head control section HC. The head control section HC is configured to have a shift register 211 which stores the drive pulse selection data SI & SP for designating the piezoelectric element PZT corresponding to the nozzle ejecting a liquid, a latch circuit 212 which temporarily stores data of the shift register 211, and a level shifter 213 which applies a voltage of the drive signal COM to the piezoelectric element PZT by converting a level of an output of the latch circuit 212 to supply to a selection switch 201.

The pieces of the drive pulse selection data SI & SP are sequentially input to the shift register 211, and a storage region is sequentially shifted from a first stage to latter stages in accordance with an input pulse of the clock signal SCK. The latch circuit 212 latches each output signal of the shift register 211 in response to the input latch signal LAT, after the pieces of the drive pulse selection data SI & SP are stored in the shift register 211 related to the corresponding the number of the nozzle. The signals stored in the latch circuit 212 are converted into a voltage level in which the selection switch 201 in a next stage can be turned on and off by the level shifter 213. This is because the drive signal COM is charged with a high voltage compared to an output voltage of the latch circuit 212 and a range of an operation voltage of the selection switch 201 is set high in accordance therewith. Therefore, the piezoelectric element PZT in which the selection switch 201 is closed by the level shifter 213 is connected to the drive signal COM (drive pulse PCOM) as a connection of the drive pulse selection data SI & SP.

After the drive pulse selection data SI & SP of the shift register 211 is stored in the latch circuit 212, subsequent printing information is input to the shift register 211, thereby sequentially updating the stored data of the latch circuit 212 during an ejection of a liquid. Even after causing the piezoelectric element PZT to be separated from the drive signal COM (drive pulse PCOM), this selection switch 201 allows the input voltage of the piezoelectric element PZT to maintain the voltage immediately before being separated therefrom.

### 3.4. Drive Signal

FIG. 7 is a view describing a flow for explaining generation of the drive signal COM. As described above, the portion of the original drive signal generation section 25, the signal modulation section 26, the signal amplification section 28 (digital power amplification circuit), and the signal conversion section 29 (smooth filter) in FIG. 7 correspond to the drive signal generation section 14. The original drive signal generation section 25 generates the original drive signal 125 as in FIG. 7, for example, based on the printing data 111 from the interface section 11.

The original drive signal generation section 25 includes the CPU 12, a DAC 39 and the like as described below, and the CPU 12 selects original drive data based on the printing data 111 to output to the DAC 39, thereby generating the original drive signal 125.

The signal modulation section 26 performs a predetermined modulation to generate the modulation signal 126 upon the original drive signal 125 from the original drive signal generation section 25. As described below, a modulation using an error amplifier 37 is performed as the predetermined modulation in the embodiment. However, a basic modulation operation thereof is the same as that of a pulse-density modulation (PDM). Another modulation method such as a pulse-width modulation (PWM) may be used as the predetermined modulation.

The signal amplification section 28 receives the modulation signal 126 to perform power amplification, and the signal conversion section 29 smooths the amplification modulation signal 128 to generate the analog drive signal COM.

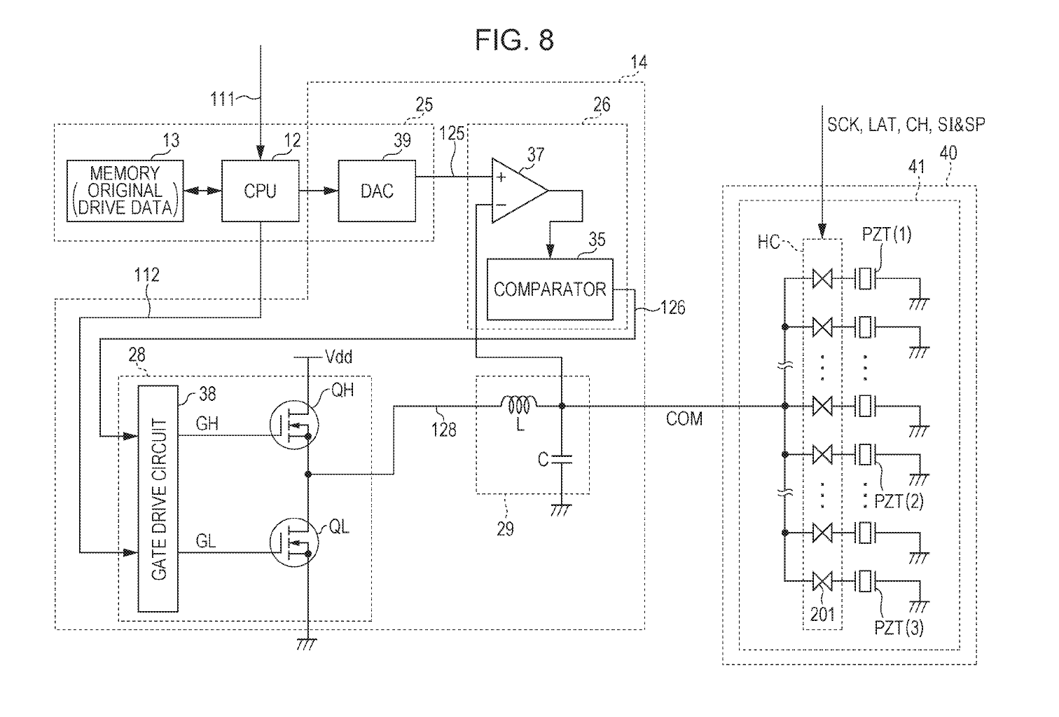

A configuration regarding a functional block illustrated in FIG. 7 will be described in detail. FIG. 8 is a detailed block diagram of the drive signal generation section 14 and the like in the printer 1 the embodiment. The head unit 40 receiving the drive signal COM generated by the drive signal generation section 14 is also illustrated in FIG. 8.

The original drive signal generation section 25 includes the memory 13 which stores the original drive data of the original drive signal 125 configured to have digital potential data and the like, the CPU 12 which reads the original drive data from the memory 13 based on the printing data 111 from the interface section 11, and the DAC 39 which converts a voltage signal output from the CPU 12 into an analog signal to output to the DAC 39 as the original drive signal 125.

The signal modulation section 26 is a circuit generating the modulation signal 126 which has the same basic modulation operation as that of the pulse-density modulation method (hereinafter, PDM method). The signal modulation section 26 includes the error amplifier 37 which amplifies an error, and a comparator 35.

In the PDM method, self-pulsation is performed by comparing an output waveform and an input waveform, thereby modulating the pulse density. Normally, a circuit which realizes a modulation through the PDM method is configured to have an integration circuit, a comparator and a delayer. A basic configuration thereof is the same as that of a generally known ΔΣ modulator. A ΔΣ modulation is one of an A/D conversion quantizing a signal. The ΔΣ modulation causes an error, that is, quantized noise generated in a quantizer (comparator) to be shifted to a higher frequency band than an input signal due to two characteristics such as over sampling and noise shaping, thereby achieving good accuracy with respect to a low band signal, and causing the quantized noise shifted to the high frequency band to be distributed throughout a broadband. Thus, a pulse frequency changes in response to an input signal level.

In the signal modulation section 26 according to the embodiment, a route in which the modulation signal 126 performs feedback via the signal amplification section 28 and the like corresponds to the delayer. The signal modulation section 26 uses the error amplifier 37 which amplifies a differential between two input signals, in place of an integrator which is often used in a modulation circuit adopting the PDM method. In this case, a feedback signal to the signal modulation section 26 is not the amplification modulation signal 128 but the drive signal COM. The quantizing is performed based on the differential between the drive signal COM and the original drive signal 125. The signal modulation section 26 according to the embodiment can reduce delay time (delay element), but for the integrator is not necessary. Thus, it is possible to achieve speed improvement in the modulation process. The signal modulation section 26 can reduce phase delay with respect to the original drive signal 125 of the drive signal COM by correcting phase advance of the error amplifier 37, for example. Since a pulsation frequency rises by decreasing the delay element, the signal modulation section 26 can perform the modulation having high reproducibility of a waveform.

The signal amplification section 28 is the digital power amplification circuit, and is configured to have a half-bridge output stage consisting of a switching element QH on a higher side and a switching element QL on a lower side for amplifying power practically, and a gate drive circuit 38 for adjusting gate input signals GH and GL of the switching element QH on the higher side and the switching element QL on the lower side based on the modulation signal 126 from the signal modulation section 26. For example, a power MOSFET can be used as the switching elements QH and QL, and the switching element is not limited thereto.

In the signal amplification section 28, when the modulation signal 126 is at a high level, a gate input signal GH of the switching element QH on the higher side is at a high level, and a gate input signal GL of the switching element QL on the lower side is at a low level. Therefore, the switching element QH on the higher side is in an ON-state and the switching element QL on the lower side is in an OFF-state. As a result, an output from the half bridge output stage becomes a supply voltage Vdd. On the contrary, when the modulation signal 126 is at a low level, the gate input signal GH of the switching element QH on the higher side is at a low level, and the gate input signal GL of the switching element QL on the lower side is at a high level. Therefore, the switching element QH on the higher side is in the OFF-state and the switching element QL on the lower side is in the ON-state. As a result, an output from the half bridge output stage becomes zero.

When an amplification instruction signal 112 output from the CPU 12 gives an instruction to stop an operation, the gate drive circuit 38 causes both the switching element QH on the higher side and the switching element QL on the lower side to be in the OFF-state. Causing both the switching element QH on the higher side and the switching element QL on the lower side to be in the OFF-state is synonymous with stopping the operation of the signal amplification section 28. Thus, an actuator consisting of the piezoelectric elements PZT which are electrically capacitive loads is maintained in a high impedance state.

The signal conversion section 29 uses a secondary filter which is a smooth filter consisting of a coil L and a capacitor C. A modulation frequency, that is, a frequency component in the pulse modulation generated in the signal modulation section 26 is attenuated and eliminated by the signal conversion section 29, thereby generating the drive signal COM to output to the head unit 40.

The head unit 40 has the heads 41 and includes a number of the piezoelectric element PZT corresponding to those of the nozzles ejecting a liquid. The first piezoelectric element PZT(1), the second piezoelectric element PZT(2) and the third piezoelectric element PZT(3) are a portion of the overall piezoelectric elements PZT (for example, several thousand piezoelectric elements). The heads 41 include the head control section HC, and the head control section HC includes the selection switch 201 for selecting whether a voltage of the drive signal COM is applied to each of the piezoelectric elements PZT. In FIG. 8, any functional block (for example, shift register 211 and the like, refer to FIG. 6) other than the cavity CA, the nozzles NZ, and the selection switch 201 of the head control section HC is omitted in the illustration.

As described above, the coil L is used for smoothing the amplification modulation signal 128 which is from the signal amplification section 28 (digital power amplification circuit) to generate the drive signal COM. However, generally, generation of heat and a loss in a coil used for smoothing the amplification modulation signal 128 which is from the digital power amplification circuit tend to account for a large portion of overall heat generation and power consumption of the liquid ejecting-type printing apparatus. Accordingly, selection of a coil which can prevent heat generation and heat loss from occurring is a major disadvantage in designing a liquid ejecting-type printing apparatus.

Particularly, in the printer 1, since the amplification modulation signal 128 at a high frequency such as the MHz order is used in order to obtain a printed matter having sufficient quality and resolution, the power consumption greatly varies depending on selection of the coil L. Hereinafter, the method of selecting a coil suitable to be used in the printer 1 will be examined.

### 4. Regarding Selection of Coil

### 4.1. Type of Core Material

Generally, a coil can be broadly classified into an air core-type coil in which an electrical wire is wound in a cylindrical shape and the inside of the cylinder is empty, and a core coil in which a winding wire is wound around a core. The air core-type coil is not suitable to be used in the printer 1 for having a great loss despite a low distortion property.

Generally, there are three types of the core material such as Mn—Zn-based ferrite (hereinafter, simply referred to as Mn—Zn-based), Ni—Zn-based ferrite (hereinafter, simply referred to as Ni—Zn-based), and dust core-based. The dust core-based indicates a core material using magnetic powder formed by a high pressure press. Rs, a resistance component of the coil differs depending on selection of the core material. The Rs is the resistance component of the coil, and includes a resistance component contributing to an iron loss (loss of core) and a resistance component contributing to a copper loss (loss of wire material). In the following, “a resistance component contributing to an iron loss (loss of core)” may be simply referred to as “the iron loss (loss of core)”, and “a resistance component contributing to a copper loss (loss of wire material)” may be simply referred to as “the copper loss (loss of wire material)”. Direct current resistance (for example, approximately 2 mΩ) of a coil is also a resistance component. However, the direct current resistance may be excluded from subjects of the examination for being too small (for example, two-digit) compared to Rs.

The coil using the Ni—Zn-based core material (hereinafter, also simply referred to as Ni—Zn-based coil) tends to have low saturation magnetic flux density compared to the coil using the Mn—Zn-based core material (hereinafter, also simply referred to as Mn—Zn-based coil) and the coil using the dust core-based core material (hereinafter, also simply referred to as dust core-based coil). The tendency denotes that there is a need to increase the number of turns, for example, compared to the coils of other types in order to obtain a desired inductance value. However, since a small-type coil L is used in the printer 1, it is difficult to greatly increase the number of turns thereof. Therefore, from a viewpoint of the saturation magnetic flux density, it is difficult to say that the Ni—Zn-based coil is suitable for the coil L of the printer 1, and it is preferable to use the Mn—Zn-based coil or the dust core-based coil. The dust core-based coil is used in this embodiment for the following reason.

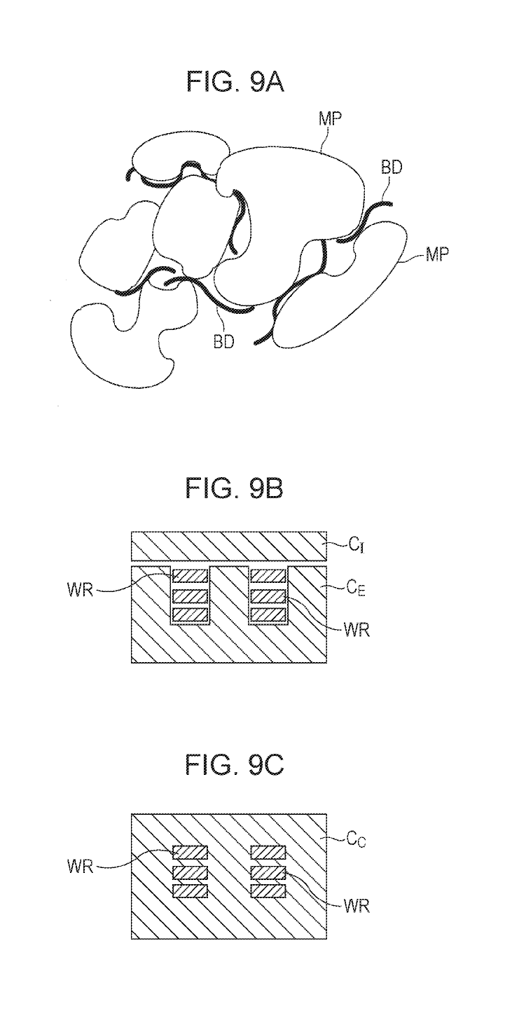

FIG. 9A is a view describing a configuration of the core material of the dust core-based coil. As illustrated in FIG. 9A, the core material of the dust core-based coil is configured to have a mixture of a magnetic particle MP which is covered by an insulating film and a thermosetting resin (binder BD). The particle size of the magnetic particle MP ranges approximately from several μm to several tens of μm, corresponding to the powder in the aspect of the invention. The binder BD corresponds to a binding material in the aspect of the invention.

As a comparative example, a cross-sectional view of a ferrite core-type coil (for example, the Mn—Zn-based coil and the Ni—Zn-based coil) is illustrated in FIG. 9B. The ferrite core-type coil is divided into a winding wire WR, and an E-core C_{E} and an I-core C_{I} to be wound with the winding wire. The E-core C_{E} and the I-core C_{I} are fixed by using an adhesive. In other words, core-to-core bonding is necessary.

In the embodiment, a metallic alloy-type coil which is the dust core-based coil using the magnetic particle MP of a metallic alloy is used. In the metallic alloy-type coil, a core C_{C} which is produced with a mixture of the magnetic particle MP and the binder BD, and the winding wire WR are subjected to integral compacting. In other words, the metallic alloy-type coil can be produced by inserting the air core coil (winding wire WR) into a die, inputting a measured core material, and performing high pressure pressing. The core C_{C} is not divided into the E-core C_{E} and the I-core C_{I} as the ferrite core-type coil, and thus, there is no need of the core-to-core bonding in the metallic alloy-type coil. In the metallic alloy-type coil, there is a wide range of selection for the core material, and magnetic leakage in a closed magnetic circuit is suppressed by using the core C_{C} having no magnetic saturation. Thus, it is possible to allow a large current to flow for a relatively small-type coil. In the metallic alloy-type coil, the thickness of the binder BD which affects a gap of the magnetic particle MP can be made to correspond to a core gap (for example, the gap between the E-core C_{E} and the I-core C_{I}) of the ferrite core-type coil. Therefore, the characteristics of the metallic alloy-type coil can vary depending on the selection of the binder BD. The characteristics also can vary depending on the particle size of the magnetic particle MP or a pressing pressure during the integral compacting. A relationship between the particle size of the magnetic particle MP and the characteristics of the metallic alloy-type coil will be described later.

### 4.2. Regarding Relationship Between Coil and Rs

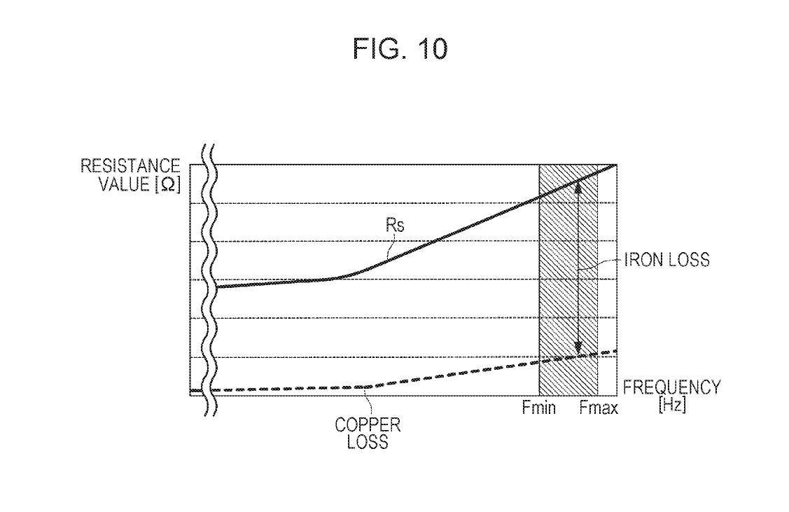

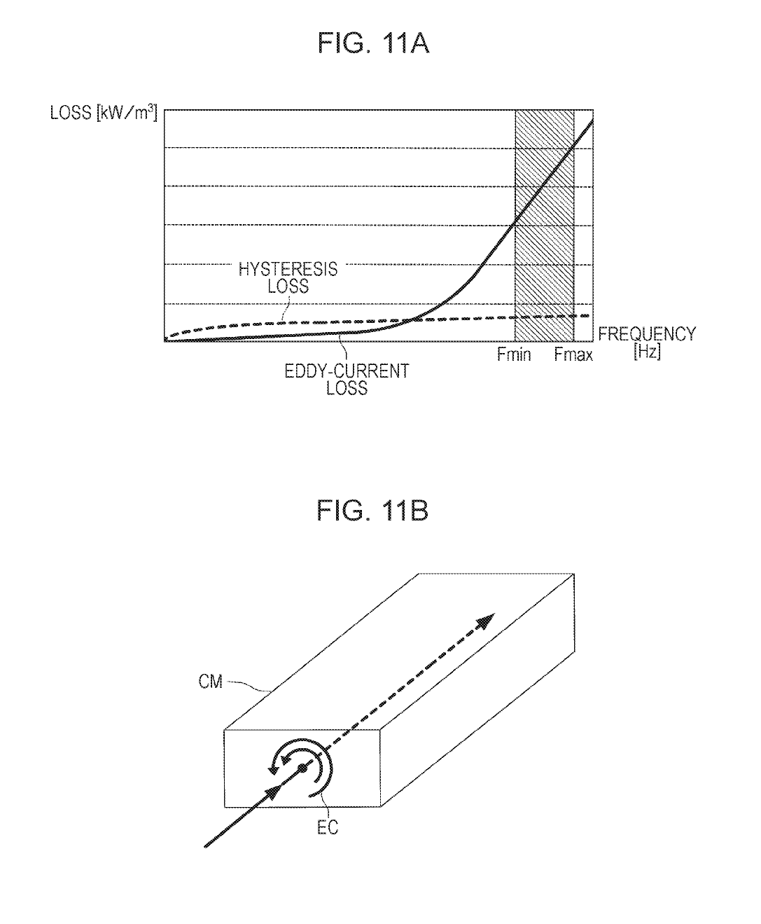

Hereinafter, the Rs of the coil L (refer to FIG. 8) will be described with reference to FIGS. 10 to 11B. FIG. 10 is a view describing a ratio of the copper loss to the iron loss in Rs. A logarithmic scale is used as the vertical axis (resistance value) in FIG. 10.

As described above, the Rs is the resistance component of the coil L including the iron loss and the copper loss. The Rs described in a solid line in FIG. 10 is based on data measured by an impedance analyzer. The amplification modulation signal 128 input to the coil L of the printer 1 can secure a frequency within a range from Fmin to Fmax in FIG. 10, during a normal operation of printing performed by the printer 1. In other words, in the embodiment, the Fmin is 1 MHz and the Fmax is approximately 8 MHz. The reason for a frequency band of an AC component of the amplification modulation signal 128 being equal to or higher than 1 MHz, and lower than 8 MHz will be described later.

An electrical resistance Rc of the copper loss in the Rs can be calculated through Expression 1, using electrical resistivity ρ, a length L of a conductor, and a cross-sectional area S₀ of the conductor.

$${R}_{c} = \frac{ρ L}{{S}_{0}} \qquad ( 1 )$$

The copper loss described in a dotted line in FIG. 10 indicates the Rc of Expression 1. Accordingly, in FIG. 10, a difference between the Rs in the solid line and the copper loss in the dotted line denotes the iron loss. Since the vertical axis (resistance value) is the logarithmic scale, there is a relationship of iron loss >>copper loss within the range of the frequency from Fmin to Fmax, and thus, the iron loss is dominant in a loss of the coil L of the printer 1.

The iron loss W is the sum total of a hysteresis loss Wₕ and an eddy-current loss Wₑ, and can be described as Expression 2 below.

W=Wₕ+Wₑ≈(Kₕ×Bₘ^{η1}×f)+(Kₑ₁×Bₘ^{η2}×f²) (2)

In Expression 2, Bₘ indicates magnetic flux density, each of Kₕ, Kₑ₁, η₁ and η₂ indicates a constant, and f indicates a frequency of a signal of the coil L. The hysteresis loss Wₕ is a loss occurring when a direction of a magnetic field in a core varies. Since the hysteresis loss Wₕ occurs proportionately to the number of magnetic variations, the hysteresis loss Wₕ is proportional to the frequency f. Meanwhile, the eddy-current loss Wₑ is a loss occurring due to generation of an electromotive force through electromagnetic induction in accordance with variations of the magnetic field in the core, and due to an induced current flowing the core. Volume of the eddy-current flowing the core is proportional to a magnetic variation speed, that is, the frequency f. Since the volume is multiplied by the frequency (the number of occurrences), the eddy-current loss is proportional to the square of the frequency f.

FIG. 11A is a view describing a ratio of the eddy-current loss to the hysteresis loss, and is based on the above-described Expression 2. The printer 1 uses the amplification modulation signal 128 which is used within a range of a high frequency (Fmin to Fmax). Therefore, as illustrated in FIG. 11A, the eddy-current loss proportional to the square of the frequency f is dominant in the same range, and most of the iron loss can be regarded as the eddy-current loss.

FIG. 11B is a view for describing an eddy-current EC. The eddy-current EC is generated by the generation of the electromotive force through the electromagnetic induction in accordance with the variations of the magnetic field (dotted line in FIG. 11B) inside the core CM. In order to suppress the eddy-current loss, it is necessary to decrease an eddy-current, that is, to select a material having great electrical resistance for the core CM. Accordingly, regarding the core material for the dust core-based coil, the eddy-current loss can be suppressed by combining the magnetic particle MP and the binder BD, and selecting a core material having a great Rs, which is the resistance component. As described above, the iron loss rather than the copper loss, and then, the eddy-current loss in the iron loss is dominant in the printer 1 using the amplification modulation signal 128 used in the range of the high frequency. Therefore, since the eddy-current loss can be suppressed by appropriately selecting the magnetic particle MP and the binder BD, it is possible to suppress heat generation and a loss of the coil L and to provide the printer 1 with low power consumption.

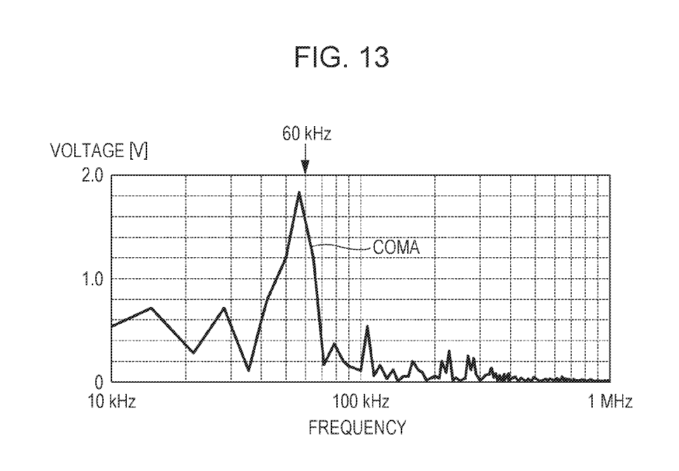

The frequency band of the AC component in the amplification modulation signal 128 is equal to or higher than 1 MHz for the following reason. COMA in FIG. 13 indicates a result of a frequency spectrum analysis regarding a pulse waveform (for example, a waveform of a portion of the original drive signal 125 corresponding to PCOM 2 in FIG. 5) in the original drive signal 125. According to FIG. 13, it is known that a frequency in a range of approximately 10 kHz to 400 kHz is included. In order to obtain the drive signal COM by amplifying in the signal amplification section 28 which is the digital power amplification circuit, it is necessary for the signal amplification section 28 to be driven at a switching frequency equal to or higher than ten times that of the frequency component included in the original drive signal 125 at the minimum. If the switching frequency of the signal amplification section 28 is lower than ten times as much compared to the frequency spectrum included in the original drive signal 125, it is not possible to modulate and amplify a high frequency spectrum component included in the original drive signal 125, thereby causing the sharpness (edge) of the drive signal COM to become obtuse and rounded. If the drive signal COM becomes obtuse, movements of the piezoelectric element PZT which is operated in accordance with the rising edge and falling edge of the waveform become dull, and thus, there is a possibility that an ejection amount from the nozzle NZ may be unstable or ejection failure may occur. In other words, there is a possibility of an occurrence of an unstable drive. According to FIG. 13, the high frequency spectrum component of the pulse waveform in the original drive signal 125 has the peak at approximately 60 kHz, and many components thereof have frequencies of lower than 100 kHz. For this reason, it is desirable to drive the signal amplification section 28 at the switching frequency to the extent of 1 MHz which is ten times 100 kHz, at the minimum.

The frequency component included in the original drive signal 125 varies depending on a size of an ejected ink droplet or a waveform of the original drive signal 125 corresponding to a size of printing dots. For example, a waveform of a portion of the original drive signal 125 used in the spectrum analysis in FIG. 13 is an original drive signal 125 for ejecting an ink droplet having a size smaller than a standard size, and thus, a vibration width is small, at approximately 2 V, as illustrated in FIG. 13. In this manner, in order to eject the ink droplet having a small size, the piezoelectric element PZT is caused to rapidly move so that a small ink droplet is ejected. Therefore, the drive signal COM needs to include many high frequency spectrum components, and the piezoelectric element PZT needs to move at a high speed as a matter of circumstance in order to perform high-speed printing, and many high frequency spectrum components need to be included. In other words, as a higher speed and higher resolution are pursued in printing, the lower limit of a demanded frequency tends to be higher. The drive signal COM in the embodiment is designed for general household and office use, and is designed in consideration of printing approximately five sheets of an A4-sized printed matter per minute to the specification of 5,760×1,440 dpi, using 180 piezoelectric elements PZT.

The frequency band of the AC component of the amplification modulation signal 128 is lower than 8 MHz, for the following reason. When the switching frequency is high, if switching is attempted at a high pressure and a high frequency so as to be able to drive the piezoelectric element PZT, various disadvantages occur such as generation of noise caused by increased junction capacitance, and an increase of a switching loss due to high frequency drive, for a structural reason of switching transistors (QH, QL). Particularly, the increase of the switching loss may become a significant disadvantage. In other words, the increase of the switching loss may result in impairment of a power saving property and a low pyrogenic property in which the digital power amplification circuit (digital amplifier) is relatively advantageous compared to an amplifier of class AB.

In the embodiment, when compared to an analog amplifier (amplifier of class AB) hitherto used, a result is obtained in which the digital amplifier is advantageous over the analog amplifier up to 8 MHz. However, when the transistor is driven at a frequency equal to or higher than 8 MHz, the amplifier of class AB may be advantageous over the digital amplifier.

### 4.3. Regarding Composition of Core Material

As described above, the coil L of the embodiment is the metallic alloy type and the core material thereof is the material in which the magnetic particle MP and the binder BD are mixed is used. It is preferable that the magnetic particle MP be soft magnetic powder (hereinafter, the magnetic particle MP is simply referred to as “soft magnetic powder”) and be a metal described below.

The soft magnetic powder is constituted by metallic powder having Fe (iron) as the main component. It is preferable for the soft magnetic powder to have an average particle size ranging from 5 μm to 25 μm and to have the maximum particle size of less than 63 μm, and the detailed description will be given later.

Fe is the main element constituting the soft magnetic powder and greatly affects basic magnetic characteristics and mechanical characteristics of the soft magnetic powder. Generally, metallic powder having Fe as the main component enables manufacturing of a dust core having high magnetic flux density and high strength. The term “main component” denotes a component having the highest content rate among each of the components constituting the soft magnetic powder.

It is preferable that the content rate of Fe in the soft magnetic powder range approximately from 50% by weight to 99.5% by weight, and it is more preferable to range approximately from 60% by weight to 95% by weight. Accordingly, it is possible to obtain the soft magnetic powder having high magnetic flux density and high strength with which the dust core can be securely manufactured. Therefore, miniaturization thereof can be achieved while various characteristics of the dust core are maintained.

In the related art, for the purpose of decreasing the eddy-current loss of the dust core, an attempt has been made to minimize the average particle size of the soft magnetic powder constituting the dust core. According to some experiments, the eddy-current loss of the dust core tends to greatly change by controlling not only the average particle size of the soft magnetic powder, but also the maximum particle size in the high frequency band. Even though the soft magnetic powder having Fe as the main component and being regulated not only to have the small average particle size ranging from 5 μm to 25 μm but also to have the maximum particle size of less than 63 μm is used in the high frequency band, it is possible to manufacture the dust core in which the eddy-current loss is sufficiently small.

When the soft magnetic powder and the binding material are subjected to pressurizing and compacting, the contact area between the soft magnetic powder and the binding material increases, and fixing strength in the interface therebetween increases by causing the average particle size and the maximum particle size to be small within the above-described range. Therefore, according to the soft magnetic powder of which particle size is controlled to be within the above-described range, it is possible to manufacture the dust core having the high mechanical strength.

Since filling rate of the particles can be enhanced by controlling the average particle size and the maximum particle size in the above-described manner, the dust core having higher density can be obtained. Accordingly, it is possible to obtain the dust core particularly having high magnetic permeability or magnetic flux density. As a result, the dust core can be miniaturized while maintaining the magnetic characteristics, and the magnetic characteristics of the dust core can be enhanced while maintaining the size. The term “maximum particle size” denotes a particle size in which the accumulated weight is 99.9%.

As described above, the average particle size of the soft magnetic powder ranges from 5 μm to 25 μm. However, it is preferable to range approximately from 7 μm to 20 μm, and more preferable to range approximately from 9 μm to 15 μm. When the dust core is manufactured by using such soft magnetic powder of which the average particle size is small, a flowing path of the eddy-current becomes particularly shortened, and thus, it is possible to further decrease the eddy-current loss of the dust core.

If the average particle size of the soft magnetic powder falls short of the lower limit value, compactibility of the mixture is deteriorated when the soft magnetic powder and the binding material are mixed to be subjected to the pressurizing and the compacting, and thus, there is a possibility that magnetic permeability of the dust core to be obtained may be deteriorated. In contrast, if the average particle size of the soft magnetic powder exceeds the upper limit value, the flowing path of the eddy-current becomes remarkably lengthened in the dust core, and thus, there is a possibility that the eddy-current loss may rapidly increase.

It is preferable that the soft magnetic powder further contain Si (silicon). Si is a component which can enhance the magnetic permeability of the soft magnetic powder. Moreover, Si is a component in which the induced current generated in the dust core can be decreased and the eddy-current loss can be decreased since the specific resistance of the soft magnetic powder increases by adding Si.

It is preferable that the content rate of such Si range approximately from 1% by weight to 8% by weight, and it is more preferable to range approximately from 2% by weight to 6% by weight. When the content rate of Si is set within the above-described range, it is possible to prevent the density of the soft magnetic powder from being remarkably lowered, and to obtain the soft magnetic powder with which the dust core having higher magnetic permeability and having low eddy-current loss can be manufactured.

It is preferable that the soft magnetic powder further contain Cr (chromium). Cr bonds with atmospheric oxygen, thereby easily generating an oxide (for example, Cr₂O₃ and the like) which is chemically stable. Therefore, the soft magnetic powder containing Cr excels in corrosion resistance. Moreover, Cr is a component in which the eddy-current loss of the dust core can be decreased since the specific resistance of the soft magnetic powder increases by adding Cr.

It is preferable that the content rate of such Cr range approximately from 1% by weight to 13% by weight, and it is more preferable to range approximately from 2% by weight to 10% by weight. When the content rate of Cr is set within the above-described range, it is possible to prevent the density thereof from being remarkably lowered, and to obtain the soft magnetic powder with which the dust core having excellent corrosion resistance and having low eddy-current loss can be manufactured.

The reason for being able to decrease a high frequency loss by regulating the maximum particle size can be considered as follows. The distribution of the magnetic flux density in the dust core is not uniform, for example, since a surface in contact with the compacting punch has the highest compacting density, the surface has the high magnetic density and can be referred to as the site generating more eddy-current loss. As the site where magnetic flux is concentrated in the similar manner, coarse particles can be exemplified. For two reasons, the increase of the eddy-current due to the large particle size in addition to the increase of the eddy-current due to the concentration of the magnetic flux overlap, when the coarse particles equal to or larger than 63 μm are mixed in, it is considered that the core loss extremely increases.

Since a pressure is applied during the compacting due to the coarse particles, the density around the coarse particles tends to be high, and thus, this also becomes a factor to concentrate the magnetic flux. It is considered that insulating is easily broken due to a high pressure. As a result, it is considered that the eddy-current between the particles is generated and increases the loss.

Such soft magnetic powder may include other components, for example, C (carbon), P (phosphorus), S (sulfur), Mn (Manganese) which may be mixed in inevitably during the manufacturing process. In this case, it is preferable that the sum total of the content rates of other components be equal to or lower than 1% by weight.

Such soft magnetic powder is manufactured through various powderization methods, for example, an atomizing method (for example, a water atomizing method, a gas atomizing method, a high-speed rotation water current atomizing method), a reduction method, a carbonyl process, and crushing.

Among these, it is preferable that the soft magnetic powder be manufactured through the atomizing method. According to the atomizing method, extremely fine powder can be efficiently manufactured. Since the shape of each particle of the powder becomes close to a spherical shape, the filling rate of the soft magnetic powder can be increased when manufacturing the dust core. Accordingly, a dust core having higher density can be manufactured, thereby making it possible to obtain the dust core having high magnetic permeability and high magnetic flux density.

When the water atomizing method is used as a atomizing method, the pressure of atomizing water to be ejected is preferably to range approximately from 75 MPa to 120 MPa (750 kgf/cm² to 1,200 kgf/cm²), without being limited thereto. The water temperature of the atomizing water is preferably to range approximately from 1° C. to 20° C., without being limited thereto.

Classification of particles may be performed as necessary with respect to the soft magnetic powder obtained through such a manner. As the method of the classification, for example, dry-type classification such as sieving classification, inertial classification, and centrifugal classification; and wet-type such as sedimentary classification can be exemplified.

Among these, it is preferable to use the sieving classification when obtaining the soft magnetic powder. The particles having the particle size equal to or greater than a sieve opening are securely removed by adopting the sieving classification, and thus, the maximum particle size can be securely controlled to a predetermined value. Accordingly, the soft magnetic powder can be easily manufactured. The obtained soft magnetic powder may be granulated as necessary.

The core material herein is not only the powder (magnetic particle MP) but also a mixture containing the binding material (binder BD). However, as a constituent material of the binding material, for example, organic binders such as a silicone-based resin, an epoxy-based resin, a phenol-based resin, a polyamide-based resin, a polyimide-based resin, and a polyphenylene sulfide-based resin; and inorganic binders such as magnesium phosphate, calcium phosphate, zinc phosphate, manganese phosphate, phosphate such as cadmium phosphate, and silicate such as sodium silicate (water glass) can be exemplified. Particularly, thermosetting polyimide or an epoxy-based resin is preferable. These resin materials are easily hardened by heating and are excellent in heat resistance, and thus, it is possible to enhance ease of manufacturing and heat resistance of the coil.

The ratio of the binding material to the soft magnetic powder slightly differs depending on the target magnetic permeability and the magnetic flux density, the allowed eddy-current loss, or the like for the core to be manufactured. However, it is preferable to range approximately from 0.5% by weight to 5% by weight, and more preferable to range approximately from 1% by weight to 3% by weight. Accordingly, each of the particles of the soft magnetic powder is reliably insulated from each other and the density of the core is secured to a certain extent, and thus, it is possible to prevent the magnetic permeability and the magnetic flux density of the core from being extremely deteriorated. As a result, a core having the higher magnetic permeability and a lower loss property can be obtained.

An organic solvent is not particularly limited as long as the solvent can dissolve the binding material. For example, various solvents such as toluene, isopropyl alcohol, acetone, methyl ethyl ketone, chloroform, and ethyl acetate can be exemplified. Various additives may be added in the mixture for an arbitrary purpose as necessary.

The surface of the soft magnetic powder is covered by such a binding material. Accordingly, since particles of the soft magnetic powder are respectively insulated by the binding material having an insulation property, even though a magnetic field which changes in response to a high frequency is applied to the core, the induced current in accordance with the electromotive force generated through the electromagnetic induction with respect to the variations of the magnetic field reaches only a relatively narrow region of each particle. Therefore, a loss by Joulian heat due to the induced current can be minimized. Since the loss by Joulian heat incurs heat generation of the core, a calorific value of the coil can be reduced by suppressing the loss by Joulian heat.

As the compacting method of the coil, without being particularly limited, for example, methods of pressing molding, extrusion molding, and injection molding can be exemplified.

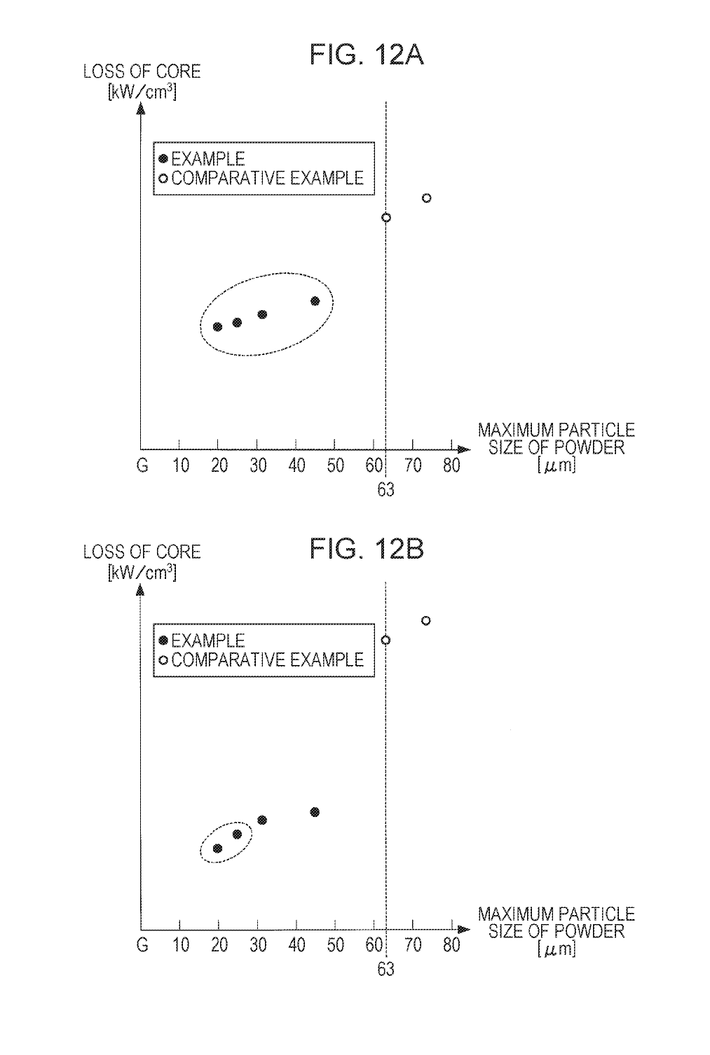

FIGS. 12A and 12B are results of a measured loss (core loss) of the coil in which the maximum particle size is changed regarding the coil produced with the above-described mixture. The measured frequency of FIG. 12A is 300 kHz, and the measured frequency of FIG. 12B is 500 kHz. However, the tendency is the same even though the frequency is further increased.

As in FIGS. 12A and 12B, when the maximum particle size of the soft magnetic powder is less than 63 μm, it is recognized that the loss of the dust core is extremely decreased compared to a case of equal to or larger than 63 μm. Meanwhile, the core obtained in each comparative example, that is, all the dust cores including the soft magnetic powder in which the maximum particle sizes are equal to or larger than 63 μm have great loss.

Among the dust cores obtained through each example, the dust cores (the dust cores surrounded by a broken-lined oval in FIG. 12B) satisfying the condition in which the product f×d of a frequency f and a maximum particle size d is equal to or less than 15,000 are particularly suppressed to have relatively small losses in each frequency. The tendency becomes more remarkable as the frequency becomes higher.

As described above, in the printer 1 using the amplification modulation signal 128 having a high frequency, heat generation and a loss can be suppressed in the coil L of the metallic alloy type when smoothing the amplification modulation signal 128, and thus, it is possible to provide the printer 1 having high conversion efficiency and low power consumption. In the embodiment, the similar effect can be achieved without being limited to the line head-type liquid ejecting apparatus (for example, including the serial head-type liquid ejecting apparatus) as long as the amplification modulation signal 128 having a high frequency is used in the liquid ejecting-type printing apparatus.

### 5. Others

The aspects of the invention include substantially the same configuration (for example, a configuration having the same function, method and result; or a configuration having the same object and effect) as the configuration described in the examples and application examples. The aspects of the invention also include a configuration of which a portion that is nonessential in the configuration described in the examples and the like is replaced. The aspects of the invention further include a configuration exhibiting the same operation effect or a configuration through which the same object can be achieved, as the configuration described in the examples and the like. The aspects of the invention yet include a configuration in which a known technology is added to the configuration described in the examples and the like.

What is claimed is:

1. A liquid ejecting apparatus comprising:
a signal modulator that modulates a first drive signal to generate a modulation signal;
a signal amplifier that amplifies the modulation signal to generate an amplified modulation signal;
a coil that smoothes the amplified modulation signal to generate a second drive signal;
a piezoelectric element that deforms when the second drive signal is applied thereto;
a cavity that expands or contracts due to deformation of the piezoelectric element; and
a nozzle that communicates with the cavity and ejects a liquid in accordance with increase and decrease of a pressure inside the cavity;
wherein the coil includes magnetic particles, and
wherein a product of a frequency of the amplified modulation signal measured in kHz and a size of a largest one of the magnetic particles measured in μm is equal to or less than 15,000.

2. The liquid ejecting apparatus according to claim 1,
wherein the frequency of the amplified modulation signal is equal to or higher than 1 MHz.

3. The liquid ejecting apparatus according to claim 1,
wherein the frequency of the amplified modulation signal is lower than 8 MHz.

4. The liquid ejecting apparatus according to claim 1,
wherein the size of a largest one of the magnetic particles is less than 63 μm.

5. The liquid ejecting apparatus according to claim 1,
wherein an average size of the magnetic particles ranges 5 μm to 25 μm.
